(19) United States
(12) Patent Application Publication
(10) Pub. No.: US 2020/0043380 A1
(43) Pub. Date: Feb. 6, 2020

(54) Flexible Yard Signs

(71) Applicant: Stewart Huntington, Marietta, GA (US)

(72) Inventor: Stewart Huntington, Marietta, GA (US)

(21) Appl. No.: 16/531,054

(22) Filed: Aug. 3, 2019

Related U.S. Application Data
(60) Provisional application No. 62/714,339, filed on Aug. 3, 2018.

(51) Int. Cl. G09F 7/22; G09F 7/06; G09F 7/08

(52) U.S. Cl. CPC G09F 7/22; G09F 2007/1886; G09F 7/08; G09F 7/06

(57) ABSTRACT

A flexible yard sign that includes a spike, a platform attached to the spike, a spring attached at one end of the platform, and a sign panel secured to the end of the spring opposite the platform, installable with the spike portion inserted vertically into the ground, so that the spring and sign panel combination extend above the ground in a manner that provides for the combination to flex or bend when contacted by another object and then return to its original or upright position after contact.

### CROSS-REFERENCE TO RELATED APPLICATIONS

This application claims the benefit of U.S. Provisional Application No. 62/714,339, entitled “Flexible Yard Signs,” filed Aug. 3, 2018, which is incorporated herein by reference as if set forth herein in its entirety.

### BACKGROUND

This invention pertains to yard signs. More particularly, this invention pertains to a flexible yard sign that provides for flexing or bending when contacted or disrupted by another object or person and then returning to its original or upright position afterward.

### BRIEF SUMMARY

According to one embodiment of the present invention, a flexible yard sign includes a spike, a platform attached to the spike, a spring attached at one end of the platform, and a sign panel secured to the end of the spring opposite the platform, is provided. The flexible yard sign provides for flexing or bending when contacted by another object and then returning to its upright position afterward. When installed with the spike portion inserted vertically into the ground, the spring and sign panel combination extend above the ground in a manner that provides for the combination to flex or bend when contacted by another object and then return to its original or upright position.

According to one embodiment, a flexible yard sign is provided that maintains an upright position upon contact, and includes a spike for insertion into ground via a pointed end, a platform attached to the spike opposite the pointed end, a spring attached to the platform and extending from the platform in a direction opposite the pointed end, and a sign panel affixed to the spring, so that the spring together with the sign panel flexes or bends when contacted by another object and then returns to an original upright position afterward.

In one embodiment, the sign panel includes parallel rows of holes for attachment to the spring. The parallel rows of holes correspond to the number of holes in each row so that the spring is affixed to the sign panel via twisting the spring through the parallel rows of holes.

In one embodiment, the platform includes a plurality of prongs for securing the spring to the platform.

In one embodiment, the spike has a twisted rectangular shape along its axis length to provide strength for holding the spike within the ground.

According to another embodiment, a flexible yard sign is provided that maintains an upright position upon contact, and includes a spike portion that includes a pointed end and a platform opposite the pointed end, for insertion into the ground via the pointed end, a spring attached to the platform and extending from the platform in a direction opposite the pointed end, and a sign panel secured to the spring, so that the spring together with the sign panel flexes or bends when contacted by another object and then returns to an original upright position afterward.

In one variation of this embodiment, the sign panel includes parallel rows of holes for attachment to the spring. The parallel rows of holes correspond to the number of holes in each row so that the spring is affixed to the sign panel via twisting the spring through the parallel rows of holes.

In another variation of this embodiment, a mount is secured within the spring opposite the platform, to provide for securement of the sign panel to the spring. The mount includes a cylindrical portion at one end, secured within the spring via threads for twisting the cylindrical portion within loops of the spring.

According to another embodiment, a flexible yard sign is provided that maintains an upright position upon contact, and includes a spike for insertion into the ground via a pointed end, a platform attached to the spike opposite the pointed end, a spring attached to the platform and extending from the platform in a direction opposite the pointed end, a mount secured within the spring opposite the platform, and a sign panel affixed to the mount, so that the spring together with the sign panel flexes or bends when contacted by another object and then returns to an original upright position afterward.

In this embodiment, the mount includes a cylindrical portion at one end, secured within the spring via threads that provide for twisting the cylindrical portion within loops of the spring. The mount further includes two flat plate sections extending from the cylindrical portion, to provide spacing for insertion of the sign panel between the two flat plates.

In one embodiment, the mount includes an adjustment opening within one plate of the two flat plate sections, suitable for insertion of an adjustment mechanism for tightening the one plate against the sign panel, so that the sign panel is secure within the mount.

Another embodiment provides a flexible yard sign that includes a spike, a platform attached to the spike, a spring attached at one end of the platform, a mount secured to the end of the spring opposite the platform, and a sign panel secured to the mount. The flexible yard sign provides for flexing or bending when contacted by another object and then returning to its upright position afterward. When installed with the spike portion inserted vertically into the ground, the spring and sign panel combination extend above the ground in a manner that provides for the combination to flex or bend when contacted by another object and then return to its original or upright position.

When installed with the spike portion inserted vertically into the ground, the spring and sign panel combination extend above the ground in a manner that provides the capability for the combination to flex or bend when contacted by another object and then return to its original or upright position. For example, when contacted by the side edge of a lawnmower base, the flexible yard sign will bend away from the lawnmower base and then return to its upright position when the lawnmower base is no longer present. When contacted or struck by a garden hose that is being dragged across a yard, the forces will typically pull or push the flexible yard sign until the garden hose moves past the upper portion or sign panel of the flexible yard sign after which the flexible yard sign will return to its original or upright position.

Other systems, methods, features and advantages of the present invention will be or become apparent to one with skill in the art upon examination of the following drawings and detailed description. It is intended that all such additional systems, methods, features and advantages be included within this description and be within the scope of the present disclosure.

### BRIEF DESCRIPTION OF THE DRAWINGS

The above-mentioned features will become more clearly understood from the following detailed description read together with the drawings in which:

FIG. 1 is a perspective view illustrating a flexible yard sign;

FIG. 2 is an exploded diagram illustrating the flexible yard sign of FIG. 1;

FIG. 3-A is a top view of the flexible yard sign of FIG. 1;

FIG. 3-B is a front view of the flexible yard sign of FIG. 1;

FIG. 3-C is a rear view of the flexible yard sign of FIG. 1;

FIG. 3-D is a bottom view of the flexible yard sign of FIG. 1;

FIG. 4-A is a side view of the flexible yard sign of FIG. 1;

FIG. 4-B is a reverse side view of the flexible yard sign of FIG. 1;

FIG. 5 is a perspective view illustrating a alternative flexible yard sign;

FIG. 6 is an exploded diagram showing the alternative flexible yard sign of FIG. 5;

FIG. 7-A is a top view of the alternative flexible yard sign of FIG. 5;

FIG. 7-B is a front view of the alternative flexible yard sign of FIG. 5;

FIG. 7-C is a rear view of the alternative flexible yard sign of FIG. 5;

FIG. 7-D is a bottom view of the alternative flexible yard sign of FIG. 5;

FIG. 8-A is a side view of the alternative flexible yard sign of FIG. 5; and

FIG. 8-B is a reverse side view of the alternative flexible yard sign of FIG. 5.

### DETAILED DESCRIPTION

A flexible yard sign that provides for flexing or bending when contacted or disrupted by another object or person and then returning to its original or upright position afterward, is disclosed. The flexible yard sign includes a spike, a platform attached to the spike, a spring attached at one end of the platform, and a sign panel secured to the end of the spring opposite the platform, and provides for flexing or bending when contacted by another object and then returning to its original or upright position afterward.

When installed with the spike portion inserted vertically into the ground, the spring and sign panel combination extend above the ground in a manner that provides for the flexible yard sign to flex or bend when contacted by another object and then return to its original or upright position.

Pet traffic is of concern to homeowners and other public areas providing green space. The need for walking and exercising one's dog(s) for example, necessitates managing the grounds to maintain the areas free from dog or other animal waste. When walking or exercising one's pet, it is not always clear when or where dogs are allowed for example. It is also easy for the pet owner to forget or otherwise neglect to clean up after their dog. Yard signs are useful as reminders to encourage the owners to clean up after their pets.

However, the nature of such signs is often such that they are damaged, pointing the wrong way, or simply knocked down. If the pet owner doesn't see the sign, then the likelihood of mistakes and/or forgetting to clean up increases. It is even more likely in neighborhood yards, that signs are lost, knocked down, and/or missing due to the nature of lawn maintenance where the signs are often moved and/or not returned.

The flexible yard sign flexes or bends when contacted by another object, such as a person, lawnmower, or hose, and then returns to its original or upright position. The flexible yard sign doesn't have to be removed for watering or mowing and is more likely to remain in its original orientation for visibility.

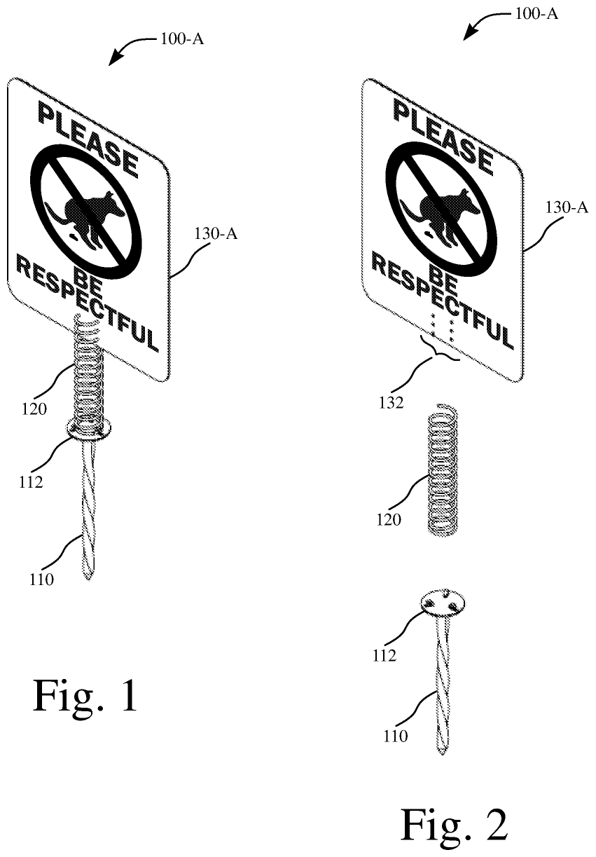

FIG. 1 is a perspective view illustrating a flexible yard sign 100-A, and FIG. 2 is an exploded diagram of the flexible yard sign 100-A. In the illustrated embodiment, the flexible yard sign 100-A includes a spike 110, a platform 112, a spring 120, and a sign panel 130-A. The platform 112 is attached to the spike 110, and one end of the spring 120 is secured to the platform 112. The sign panel 130-A is secured to the end of the spring 120 opposite the platform 112.

In a typical embodiment, the spike 110 is of sufficient length to extend into the ground and further provides strength and rigidity to prevent the flexible yard sign 100-A from being easily removed, pushed down, or inadvertently pulled from the ground into which it is placed. The spike 110 is made from metal or other rigid material having sufficient strength to maintain a generally straight configuration along its length. The spike 110 is formed of metal having a generally straight configuration that wraps or twists cylindrically around the axis along its length to provide for improved retention in the ground into which it is placed. The twist along the axis of the spike 110 provides for increased holding strength into the ground and makes the spike 110 less likely to easily pull from the ground at a direction different from the insertion angle.

A platform 112 is affixed to the end of the spike 110 that extends above the ground level when installed. The platform 112 is typically a flat or disc-like circular material made from a rigid metal such as that from which the spike 110 is made. In a typical embodiment, the platform 112 is welded to the end of the spike 110. In the illustrated embodiment, the platform 112 includes three equally spaced prongs cut from the platform 112 in a manner that provides for securing the spring 120 securely to the platform 112. In a typical embodiment, the prongs fold over the end coil of the spring 120 to secure it in place to the platform 112. In this way, the spring 120 is secured to the platform 112 while providing a flexible base attachment for the sign panel 130-A.

The spring 120 is secured to the platform 112 at one end while being secured to the sign panel 130-A at the opposing end. Springs are made from a variety of elastic materials, with the most common choice being spring steel. Spring steel includes a wide range of steels used in the manufacture of springs of an industrial nature so that objects made from spring steel return to their original shape when any deflection or twisting forces are removed. In the illustrated embodiment, the spring 120 is a helical or coil spring designed for tension. In a typical embodiment, the spring 120 is made from spring steel.

The sign panel 130-A is a flat, rectangular shaped, material suitable for including a message on either or both sides (opposing faces) of the material. In typical embodiment, the sign panel 130-A has weatherproof or water-resistant characteristics so that the flexible yard sign 130-A is durable in varying weather conditions. In the illustrated embodiment, the visible face of the sign panel 130-A includes an image of a circle with a single line extending at an angle across the circle all superimposed over an image of a dog stooping to relieve itself. In the illustrated embodiment, the message “PLEASE BE RESPECTFUL” is positioned above and below the image on the face of the sign panel 130-A. The image shown in the illustrated embodiment, is a singular example of the type messages that are envisioned for a face of the sign panel 130-A. Of course, the same image, a similar image, or even a completely different message may be included on the opposing face of the sign panel 130-A. For example, messages as common as “KEEP OFF THE GRASS” or “NO TRESPASSING” or any other suitable message may also be utilized for the sign panel 130-A.

In one embodiment, the sign panel 130-A includes a number of spring holes 132 at or near one end of the sign panel 130-A. The spring 120 is secured to one end of the sign panel 130-A via screwing or twisting the spring 120 into or through the respective spring holes 132. In the illustrated embodiment, the sign panel 130-A includes two parallel rows of spring holes 132. One of the parallel rows is offset slightly from the corresponding row to accommodate the coil offsets as the spring 120 is screwed or twisted into the sign panel 130-A. In the illustrated embodiment, each row of spring holes 132 includes three spring holes 132. In practice of course, the actual number of spring holes 132 in either row may vary according to design choice and/or the size of the sign panel 130-A. The spring 120 is secured via screwing or twisting the spring 120 into or through the respective spring holes 132 in a manner so that the coils of the spring 120 extend through a spring hole 132 and back through the next spring hole 132 successively until the coils extend through all or most of the available spring holes 132.

In the illustrated embodiment, the spring 120 is a helical or coil spring that includes a sufficient number coils that provide enough length that the flexible yard sign 100-A flexes when contacted by a dog, hose, person, lawnmower or any other yard implements that may come in contact with the flexible yard sign 100-A, for example. When installed with the spike 110 portion inserted vertically into the ground, the spring 120 and sign panel 130-A combination extend above the ground in a manner that provides the capability for the combination to flex or bend when contacted by another object and then return to its original or upright position. For example, when contacted by the side edge of a lawnmower base, the flexible yard sign 100-A will bend away from the lawnmower base and then return to its upright position when the lawnmower base is no longer present. In another example, a garden hose that is being dragged across the yard will typically pull or push the flexible yard sign 100-A until the garden hose moves past the upper portion or sign panel 130-A of the flexible yard sign 100-A after which the flexible yard sign 100-A will return to its original or upright position.

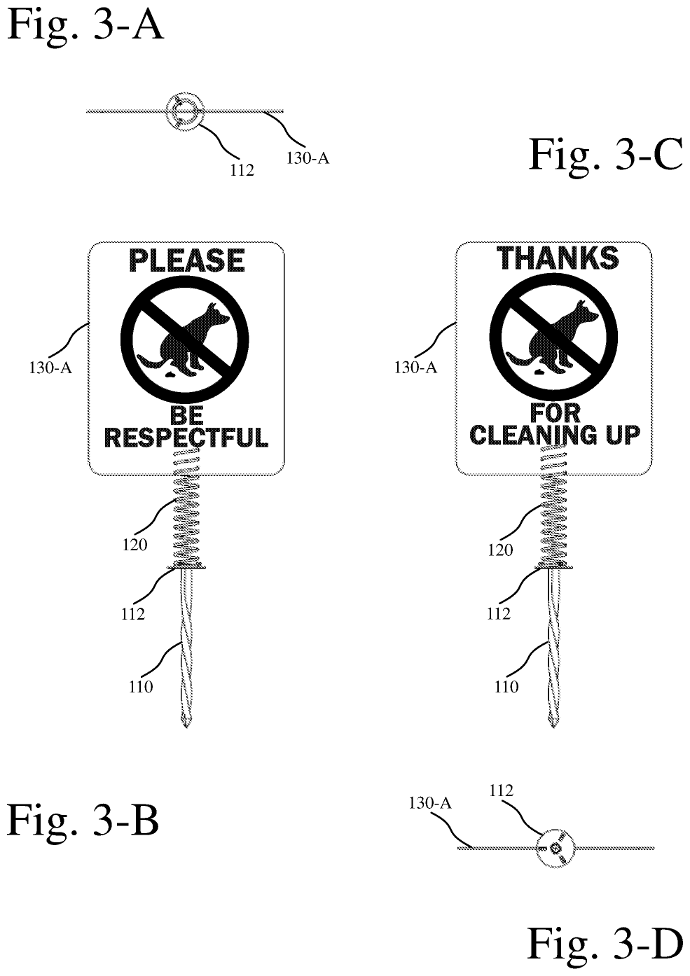

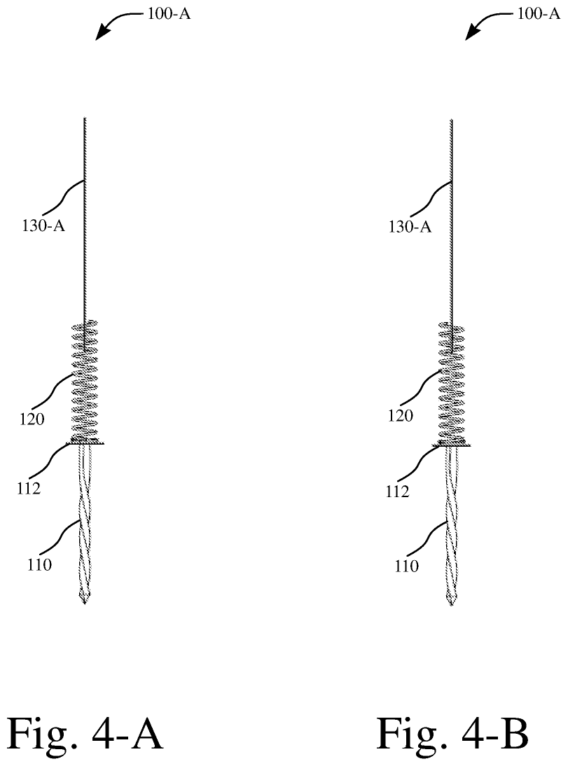

FIG. 3-A is a top view of the flexible yard sign 100-A and FIG. 3-B is a corresponding front view of the flexible yard sign 100-A. FIG. 3-C is a rear view of the flexible yard sign 100-A and FIG. 3-D is a corresponding bottom view of the flexible yard sign 100-A. Lastly, FIG. 4-A is a side view of the flexible yard sign 100-A and FIG. 4-B is a reverse side view of the flexible yard sign 100-A. It should be noted that in the illustrated example, the same image is utilized on both the front and rear faces of the sign panel 130-A. As noted above, for various embodiments the respective images may also be different or an image may only be placed on one face of the sign panel 130-A according to the specifics of the situation and/or sign requirements.

It is evident in FIG. 3-B and FIG. 3-C respectively that the coils of the spring 120 extend into one of the spring holes 132 of the sign panel 130-A on one face and coming out the same spring hole 132 of the opposite face, then extending across and into another spring hole 132 on that same face, and continuing until the coils of the spring 120 extend through the remaining spring holes 132 of the sign panel 130-A. It should also be noted that the upper coil of the spring 120 comes to rest at or near one face of the sign panel 130-A as is readily apparent in the opposing side views of FIG. 4-A and FIG. 4-B respectively.

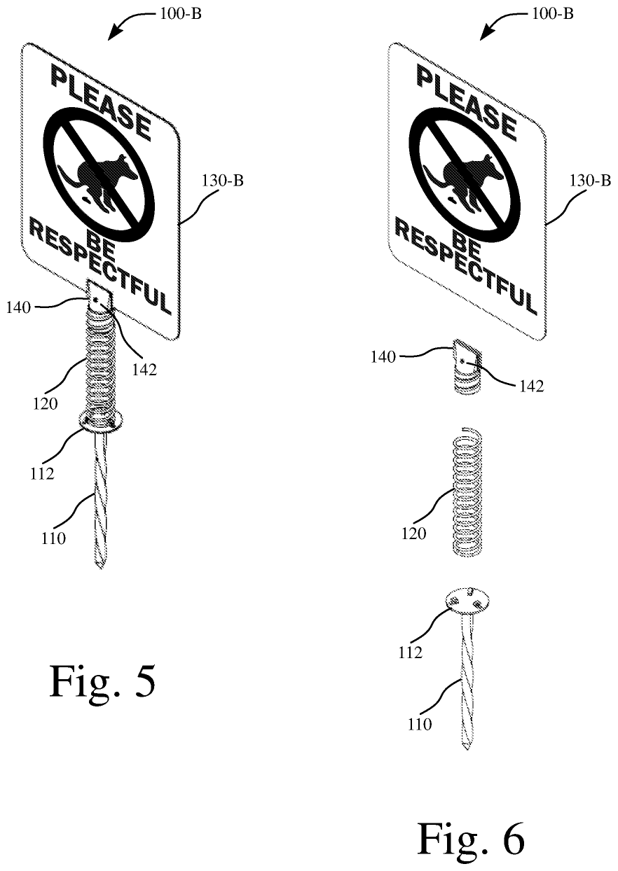

FIG. 5 is a perspective view illustrating an alternative flexible yard sign 100-B, and FIG. 6 is an exploded diagram of the alternative flexible yard sign 100-B. In the illustrated embodiment, the flexible yard sign 100-B includes a spike 110, a platform 112, a spring 120, a mount 140, and a sign panel 130-B. The platform 112 is attached to the spike 110 and the spring 120 is secured to the platform 112. The sign panel 130-B is secured to the mount 140 at the end of the spring 120 opposite the platform 112.

In a typical embodiment, the spike 110 is of sufficient length to extend into the ground and further provides strength and rigidity to prevent the flexible yard sign 100-B from being easily removed, pushed down, or inadvertently pulled from the ground into which it is placed. The spike 110 is made from metal or other rigid material having sufficient strength to maintain a generally straight configuration along its length. The spike 110 is formed of metal having a generally straight configuration that wraps or twists cylindrically around the axis along its length to provide for improved retention in the ground into which it is placed. The twist along the axis of the spike 110 provides for increased holding strength into the ground and makes the spike 110 less likely to easily pull from the ground at a direction different from the insertion angle.

A platform 112 is affixed to the end of the spike 110 that extends above the ground level when installed. The platform 112 is typically a flat or disc like circular material made from a rigid metal such as that from which the spike 110 is made. In a typical embodiment, the platform 112 is welded to the end of the spike 110. In the illustrated embodiment, the platform 112 includes three equally spaced prongs cut from the platform 112 in a manner that provides for securing the spring 120 securely to the platform 112. In a typical embodiment, the prongs fold over the end coil of the spring 120 to secure it in place to the platform 112. In this way, the spring 120 is secured to the platform 112 while providing a flexible base attachment for the sign panel 130-B.

The spring 120 is secured to the platform 112 at one end while being secured to the sign panel 130-B via a mount 140 at the opposing end. Springs are made from a variety of elastic materials, with the most common choice being spring steel. Spring steel includes a wide range of steels used in the manufacture of springs of an industrial nature so that objects made from spring steel return to their original shape when any deflection or twisting forces are removed. In the illustrated embodiment, the spring 120 is a helical or coil spring designed for tension. In a typical embodiment, the spring 120 is made from spring steel.

In the illustrated embodiment, the flexible yard sign 100-B includes a mount 140 for attaching or securing the sign panel 130-B to the spring 120. The mount 140 includes two flat portions extending from a rounded or cylindrical portion. The flat portions are separated by a space into which a portion of the sign panel 130-B is inserted. The two flat portions extend upward from the rounded or cylindrical portion that is screwed or twisted into one end of the spring 120 so that the sign panel 130-B is secured to the end of the spring 120. The mount 140 also includes an adjustment opening 142 on one of the flat portions. The adjustment opening 142 provides for insertion of a screw, fastener, adjustment screw, set screw, or any other type adjustment mechanism that is known in the art for tightening or securing a material against another material. Once the sign panel 130-B is placed between the flat portions of the mount 140, then an adjustment mechanism is utilized within the adjustment opening 142 to tighten the sign panel 130-B in place.

The sign panel 130-B is a flat, rectangular shaped, material suitable for including a message on either or both sides (opposing faces) of the material. In typical embodiment, the sign panel 130-B has weatherproof or water-resistant characteristics so that the flexible yard sign 130-B is durable in varying weather conditions. In the illustrated embodiment, the visible face of the sign panel 130-B includes an image of a circle with a single line extending at an angle across the circle all superimposed over an image of a dog stooping to relieve itself. In the illustrated embodiment, the message “PLEASE BE RESPECTFUL” is positioned above and below the image on the face of the sign panel 130-B. The image shown in the illustrated embodiment, is a singular example of the type messages that are envisioned for a face of the sign panel 130-B. Of course, the same image, a similar image, or even a completely different message may be included on the opposing face of the sign panel 130-B. For example, messages as common as “KEEP OFF THE GRASS” or “NO TRESPASSING” or any other suitable message may also be utilized for the sign panel 130-B.

In the illustrated embodiment, the spring 120 is a helical or coil spring that includes a sufficient number coils that provide enough length that the flexible yard sign 100-B flexes when contacted by a dog, hose, person, lawnmower or any other yard implements that may come in contact with the flexible yard sign 100-B, for example. When installed with the spike 110 portion inserted vertically into the ground, the spring 120 and sign panel 130-B combination extend above the ground in a manner that provides the capability for the combination to flex or bend when contacted by another object and then return to its original or upright position. For example, when contacted by the side edge of a lawnmower base, the flexible yard sign 100-B will bend away from the lawnmower base and then return to its upright position when the lawnmower base is no longer present. In another example, a garden hose that is being dragged across the yard will typically pull or push the flexible yard sign 100-B until the garden hose moves past the upper portion or sign panel 130-B of the flexible yard sign 100-B after which the flexible yard sign 100-B will return to its original or upright position.

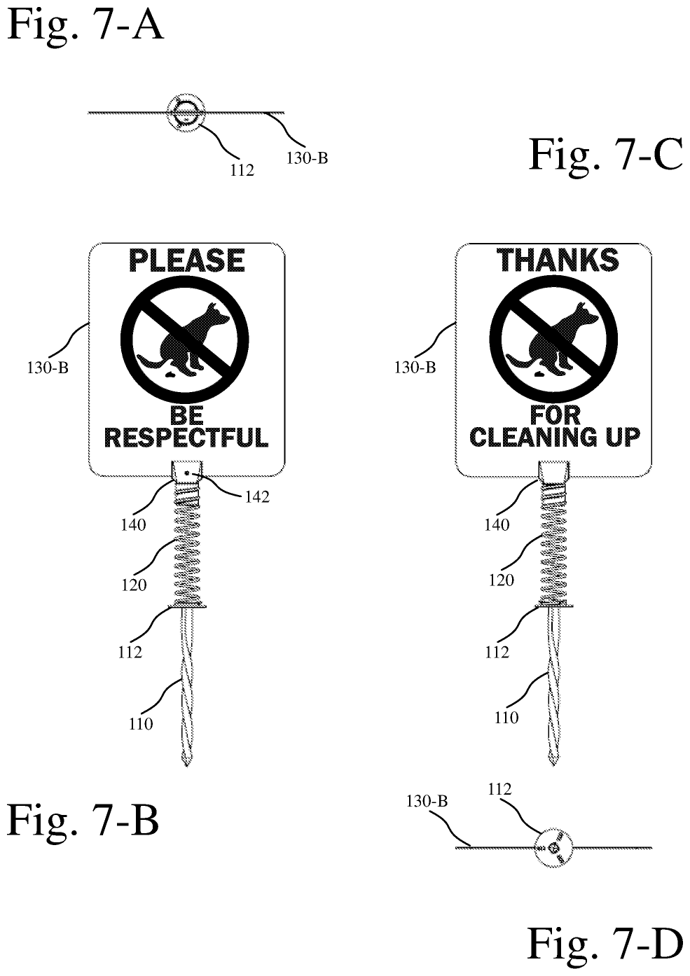

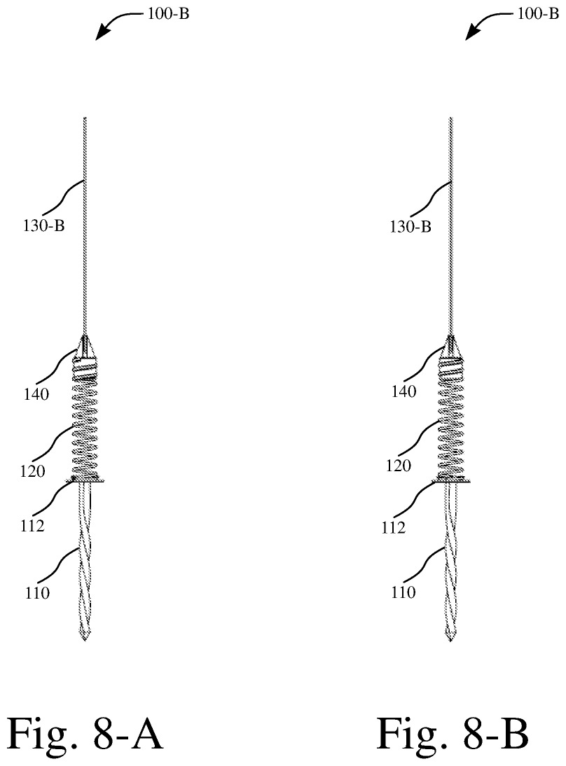

FIG. 7-A is a top view of the flexible yard sign 100-B and FIG. 7-B is a corresponding front view of the flexible yard sign 100-B. FIG. 7-C is a rear view of the flexible yard sign 100-B and FIG. 7-D is a corresponding bottom view of the flexible yard sign 100-B. Lastly, FIG. 8-A is a side view of the flexible yard sign 100-B and FIG. 8-B is a reverse side view of the flexible yard sign 100-B. It should be noted that in the illustrated example, the same image is utilized on both the front and rear faces of the sign panel 130-B. As noted above, for various embodiments the respective images may also be different or an image may only be placed on one face of the sign panel 130-B according to the specifics of the situation and/or sign requirements.

It is evident in FIG. 7-B and FIG. 7-C respectively that the mount 140 is secured within the end of the spring 120 opposite the platform 112. The mount 140 is screwed or twisted into the coils at the end of the spring 120. The adjustment opening 142 is visible in the front view of FIG. 7-B. No adjustment opening or mechanism is shown in the rear view of FIG. 7-C. In a typical embodiment, an adjustment mechanism would only be necessary on a single side of the mount 140. In other embodiments, an adjustment is utilized on both sides of the mount 140.

From the foregoing description, it will be recognized by those skilled in the art that a flexible yard sign 100-A including a spike 110, a platform 112, a spring 120, and a sign panel 130-A capable of flexing or bending when contacted by another object and then returning to its original or upright position afterward, has been provided.

When installed with the spike 110 portion inserted vertically into the ground, the spring 120 and sign panel 130-A combination extend above the ground in a manner that provides for the combination to flex or bend when contacted by another object and then return to its original or upright position.

In another embodiment, a flexible yard sign 100-B including a spike 110, a platform 112, a spring 120, a mount 140, and a sign panel 130-B capable of flexing or bending when contacted by another object and then returning to its original or upright position afterward, has been provided.

When installed with the spike 110 portion inserted vertically into the ground, the spring 120, mount 140, and sign panel 130-B combination extend above the ground in a manner that provides for the combination to flex or bend when contacted by another object and then return to its original or upright position.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A flexible yard sign for maintaining an upright position upon contact, the flexible yard sign comprising:
a spike for insertion into ground via a pointed end;
a platform attached to the spike opposite the pointed end;
a spring attached to the platform and extending from the platform in a direction opposite the pointed end; and
a sign panel affixed to the spring,
wherein the spring provides for the sign panel flexing when contacted by another object and then returning to an original upright position afterward.

2. The flexible yard sign of claim 1, the sign panel further comprising parallel rows of holes for attachment to the spring.

3. The flexible yard sign of claim 3, the parallel rows of holes further comprising a corresponding number of holes in each row so that the spring is affixed to the sign panel via twisting the spring through the parallel rows of holes.

4. The flexible yard sign of claim 1, the platform further comprising a plurality of prongs for securing the spring to the platform.

5. The flexible yard sign of claim 1, the spike further comprising a twisted rectangular shape along its axis length to provide strength for holding the spike within the ground.

6. The flexible yard sign of claim 1, wherein the spring is one of:
a helical spring; and
a coil spring.

7. A flexible yard sign for maintaining an upright position upon contact, the flexible yard sign comprising:
a spike portion that includes a pointed end and a platform opposite the pointed end, for insertion into the ground via the pointed end;
a spring attached to the platform and extending from the platform in a direction opposite the pointed end; and
a sign panel secured to the spring,
wherein the spring provides for the sign panel flexing when contacted by another object and then returning to an original upright position afterward.

8. The flexible yard sign of claim 7, the sign panel further comprising parallel rows of holes for attachment to the spring.

9. The flexible yard sign of claim 8, the parallel rows of holes further comprising a corresponding number of holes in each row so that the spring is secured to the sign panel via twisting the spring through the parallel rows of holes.

10. The flexible yard sign of claim 7, the platform further comprising a plurality of prongs for securing the spring to the platform.

11. The flexible yard sign of claim 7, the spike further comprising a twisted rectangular shape along its axis length to provide strength for holding the spike within the ground.

12. The flexible yard sign of claim 7, wherein the spring is one of:
a helical spring; and
a coil spring.

13. The flexible yard sign of claim 7, further comprising a mount secured within the spring opposite the platform, the mount providing for securement of the sign panel to the spring.

14. The flexible yard sign of claim 13, the mount further comprising a cylindrical portion at one end, the cylindrical portion secured within the spring via threads that provide for twisting the cylindrical portion within loops of the spring.

15. A flexible yard sign for maintaining an upright position when contacted, the flexible yard sign comprising:
a spike for insertion into the ground via a pointed end;
a platform attached to the spike opposite the pointed end;
a spring attached to the platform and extending from the platform in a direction opposite the pointed end;
a mount secured within the spring opposite the platform; and
a sign panel affixed to the mount,
wherein the spring provides for the sign panel flexing when contacted by another object and then returning to an original upright position afterward.

16. The flexible yard sign of claim 15, the mount including a cylindrical portion at one end, the cylindrical portion secured within the spring via threads that provide for twisting the cylindrical portion within loops of the spring.

17. The flexible yard sign of claim 16, the mount further comprising two flat plate sections extending from the cylindrical portion, the two flat plate sections providing spacing for insertion of the sign panel between the two flat plates.

18. The flexible yard sign of claim 17, the mount further comprising an adjustment opening within one plate of the two flat plate sections, the adjustment opening suitable for insertion of an adjustment mechanism for tightening the one plate against the sign panel, so that the sign panel is secure within the mount.

19. The flexible yard sign of claim 15, the spike further comprising a twisted rectangular shape along its axis length to provide retention in the ground.
